(19) United States
(12) Patent Application Publication
(10) Pub. No.: US 2020/0110424 A1
(43) Pub. Date: Apr. 9, 2020

(54) GEOFENCING OF UNMANNED AERIAL VEHICLES

(71) Applicant: Real Estate Portal USA LLC, Cleveland, OH (US)

(72) Inventors: Daniel Salvatore Oriani, Ravenna, OH (US); David Patrick Fuhry, West Farmington, OH (US); Joseph W. Harwood, Chardon, OH (US)

(21) Appl. No.: 16/589,686

(22) Filed: Oct. 1, 2019

Related U.S. Application Data
(60) Provisional application No. 62/740,532, filed on Oct. 3, 2018.

(51) Int. Cl. G05D 1/08; G05D 1/10; G05D 1/00; B64C 39/02; H04W 4/021

(52) U.S. Cl. CPC G05D 1/0808; G05D 1/101; B64C 2201/127; B64C 39/024; H04W 4/021; G05D 1/0022

(57) ABSTRACT

A method for geofencing an unmanned aerial vehicle according to one embodiment includes receiving one or more control inputs to the unmanned aerial vehicle associated with movement of the unmanned aerial vehicle, wherein the one or more control inputs are received by the mobile device prior to transmittal to the unmanned aerial vehicle, retrieving parcel data that identifies geographical boundaries of the land parcel within which the unmanned aerial vehicle is operating, determining a distance between the unmanned aerial vehicle and a boundary of the land parcel, reducing a speed value associated within the one or more control inputs to generate one or more modified control inputs in response to determining that the distance is within a threshold distance, and transmitting the one or more modified control inputs to the unmanned aerial vehicle.

### CROSS-REFERENCE TO RELATED APPLICATIONS

This application claims the benefit of U.S. Provisional Application No. 62/740,532 filed on Oct. 3, 2018, the contents of which are incorporated herein by reference in their entirety.

### BACKGROUND

Drones and other unmanned aerial vehicles (UAVs) are aircrafts without human pilots aboard during flight. The potential uses for drones range from government and military applications to commercial (e.g., aerial photography) and personal applications (e.g., competitive drone racing and other flight hobbyist activities). Some mechanisms exist to help prevent drone pilots from unintended collisions with objects and from entering airspace controlled by airports, prisons, active sporting events, and other controlled areas. However, with the rapidly expanding use of drones, there is a growing need for more sophisticated techniques of precisely controlling the geographical bounds within which a particular drone may operate at a given time.

### SUMMARY

According to an embodiment, a method for geofencing an unmanned aerial vehicle may include receiving, by a mobile device, one or more control inputs to the unmanned aerial vehicle associated with movement of the unmanned aerial vehicle, wherein the one or more control inputs are received by the mobile device prior to transmittal to the unmanned aerial vehicle, retrieving, by the mobile device, parcel data that identifies geographical boundaries of the land parcel within which the unmanned aerial vehicle is operating, determining, by the mobile device, a distance between the unmanned aerial vehicle and a boundary of the land parcel, reducing, by the mobile device, a speed value associated within the one or more control inputs to generate one or more modified control inputs in response to determining that the distance is within a threshold distance, and transmitting, by the mobile device, the one or more modified control inputs to the unmanned aerial vehicle.

In some embodiments, reducing the speed value associated with the one or more control inputs may include reducing the speed value logarithmically.

In some embodiments, reducing the speed value associated with the one or more control inputs may include reducing the speed value in response to determining that the speed value exceeds a threshold percentage of a maximum velocity of the unmanned aerial vehicle.

In some embodiments, determining the distance between the unmanned aerial vehicle and the boundary may include determining a first distance between the unmanned aerial vehicle and a first boundary of the land parcel in one of a roll direction or a pitch direction of the unmanned aerial vehicle, and reducing the speed value associated with the one or more control inputs may include reducing a first speed value associated with a first control input to generate a first modified control input in response to determining that the first distance is within a first threshold distance.

In some embodiments, the method may further include determining, by the mobile device, a second distance between the unmanned aerial vehicle and a second boundary of the land parcel in the other of the roll direction or the pitch direction of the unmanned aerial vehicle and reducing, by the mobile device, a second speed value associated with a second control input to generate a second modified control input in response to determining that the first distance is within a second threshold distance.

In some embodiments, the second threshold distance is different from the first threshold distance.

In some embodiments, the method may further include determining, by the mobile device, a second distance between the unmanned aerial vehicle and a second boundary of the land parcel in the other of the roll direction or the pitch direction of the unmanned aerial vehicle, and transmitting the one or more modified control inputs to the unmanned aerial vehicle may include transmitting the first modified control input associated with movement of the unmanned aerial vehicle in the one of the roll direction or the pitch direction and a second unmodified control input associated with movement of the unmanned aerial vehicle in the other of the roll direction of the pitch direction in response to determining that the second distance is not within a second threshold distance.

In some embodiments, the method may further include transmitting, by the mobile device and to a server, location data identifying a current location of the unmanned aerial vehicle, receiving, by the mobile device, the parcel data from the server in response to transmitting the location data of the unmanned aerial vehicle, and storing, by the mobile device, the parcel data to a memory of the mobile device, and retrieving the parcel data may include retrieving the parcel data from the memory of the mobile device.

According to another embodiment, a mobile device for controlling the operation of an unmanned aerial vehicle may include a processor and a memory comprising a plurality of instructions stored thereon that, in response to execution by the processor, causes the mobile device to receive one or more control inputs to the unmanned aerial vehicle associated with movement of the unmanned aerial vehicle, wherein the one or more control inputs are received by the mobile device prior to transmittal to the unmanned aerial vehicle, retrieve parcel data that identifies geographical boundaries of the land parcel within which the unmanned aerial vehicle is operating, determine a distance between the unmanned aerial vehicle and a boundary of the land parcel, reduce a speed value associated within the one or more control inputs to generate one or more modified control inputs in response to determining that the distance is within a threshold distance, and transmit the one or more modified control inputs to the unmanned aerial vehicle.

In some embodiments, to reduce the speed value associated with the one or more control inputs may include to reduce the speed value logarithmically.

In some embodiments, to reduce the speed value associated with the one or more control inputs may include to reduce the speed value in response to a determination that the speed value exceeds a threshold percentage of a maximum velocity of the unmanned aerial vehicle.

In some embodiments, to determine the distance between the unmanned aerial vehicle and the boundary may include to determine a first distance between the unmanned aerial vehicle and a first boundary of the land parcel in one of a roll direction or a pitch direction of the unmanned aerial vehicle, and to reduce the speed value associated with the one or more control inputs may include to reduce a first speed value associated with a first control input to generate a first modified control input in response to determining that the first distance is within a first threshold distance.

In some embodiments, the plurality of instructions may further cause the mobile device to determine a second distance between the unmanned aerial vehicle and a second boundary of the land parcel in the other of the roll direction or the pitch direction of the unmanned aerial vehicle and reduce a second speed value associated with a second control input to generate a second modified control input in response to determining that the first distance is within a second threshold distance.

In some embodiments, the second threshold distance may be different from the first threshold distance.

In some embodiments, the plurality of instructions may further cause the mobile device to determine a second distance between the unmanned aerial vehicle and a second boundary of the land parcel in the other of the roll direction or the pitch direction of the unmanned aerial vehicle, and transmittal of the one or more modified control inputs to the unmanned aerial vehicle may include transmittal of the first modified control input associated with movement of the unmanned aerial vehicle in the one of the roll direction or the pitch direction and a second unmodified control input associated with movement of the unmanned aerial vehicle in the other of the roll direction of the pitch direction in response to a determination that the second distance is not within a second threshold distance.

In some embodiments, the plurality of instructions may further cause the mobile device to transmit location data to a server identifying a current location of the unmanned aerial vehicle, receive the parcel data from the server in response to transmitting the location data of the unmanned aerial vehicle, and store the parcel data to a memory of the mobile device, and to retrieve the parcel data may include to retrieve the parcel data from the memory of the mobile device.

According to yet another embodiment, one or more non-transitory machine-readable storage media may include a plurality of instructions stored thereon that, in response to execution by a processor, causes a computing device to receive one or more control inputs to the unmanned aerial vehicle associated with movement of the unmanned aerial vehicle, wherein the one or more control inputs are received by the computing device prior to transmittal to the unmanned aerial vehicle, retrieve parcel data that identifies geographical boundaries of the land parcel within which the unmanned aerial vehicle is operating, determine a distance between the unmanned aerial vehicle and a boundary of the land parcel, reduce a speed value associated within the one or more control inputs to generate one or more modified control inputs in response to determining that the distance is within a threshold distance, and transmit the one or more modified control inputs to the unmanned aerial vehicle.

In some embodiments, to determine the distance between the unmanned aerial vehicle and the boundary may include to determine a first distance between the unmanned aerial vehicle and a first boundary of the land parcel in one of a roll direction or a pitch direction of the unmanned aerial vehicle, and to reduce the speed value associated with the one or more control inputs may include to reduce a first speed value associated with a first control input to generate a first modified control input in response to a determination that the first distance is within a first threshold distance.

In some embodiments, the plurality of instructions may further cause the computing device to determine a second distance between the unmanned aerial vehicle and a second boundary of the land parcel in the other of the roll direction or the pitch direction of the unmanned aerial vehicle and reduce a second speed value associated with a second control input to generate a second modified control input in response to a determination that the first distance is within a second threshold distance.

In some embodiments, the plurality of instructions may further cause the computing device to determine a second distance between the unmanned aerial vehicle and a second boundary of the land parcel in the other of the roll direction or the pitch direction of the unmanned aerial vehicle, and to transmit the one or more modified control inputs to the unmanned aerial vehicle may include to transmit the first modified control input associated with movement of the unmanned aerial vehicle in the one of the roll direction or the pitch direction and a second unmodified control input associated with movement of the unmanned aerial vehicle in the other of the roll direction of the pitch direction in response to a determination that the second distance is not within a second threshold distance.

Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of a system for geofencing unmanned aerial vehicles;

FIG. 2 is a simplified block diagram of at least one embodiment of a computing system;

FIG. 3 is a simplified block diagram of at least one embodiment of a control system of the unmanned aerial vehicle of FIG. 1;

FIG. 4 is a simplified flow diagram of at least one embodiment of a method for registering the location of the unmanned aerial vehicle of FIG. 1;

FIG. 5 is a simplified flow diagram of at least one embodiment of a method for geofencing the unmanned aerial vehicle of FIG. 1; and

FIG. 6 is at least one embodiment of pseudocode for executing the methods of FIGS. 4-5.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

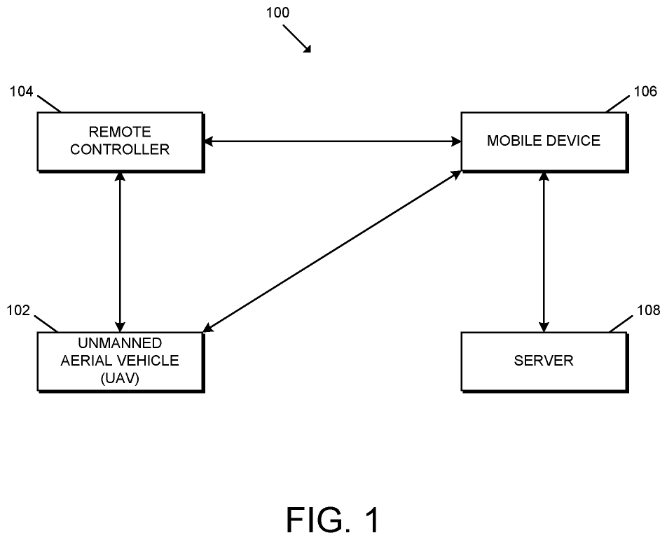

Referring now to FIG. 1, in the illustrative embodiment, a system 100 for geofencing unmanned aerial vehicles includes an unmanned aerial vehicle 102, a remote controller 104, a mobile device 106, and a server 108. As described in detail below, the system 100 allows for the precise geofencing of the unmanned aerial vehicle 102 within a geographical region (e.g., within a particular real estate parcel). Further, it should be appreciated that, in some embodiments, the particular geographical region/bounds within which the unmanned aerial vehicle 102 is geofenced may be registered or otherwise determined “on the fly” upon the initial takeoff of the unmanned aerial vehicle 102. Accordingly, in such embodiments, the pilot may launch the unmanned aerial vehicle 102 and fly the vehicle 102 as she ordinarily would while the system 100 automatically registers the geographical region/bounds and thereafter maintains the vehicle 102 within those bounds. In other embodiments, the mobile device 106 may request parcel data and/or other geographical data from the server 108 in advance of take-off and/or before communicating with the unmanned aerial vehicle 102 (e.g., such as at the time the mobile application is launched on the mobile device 106). In such embodiments, the mobile device 106 and the unmanned aerial vehicle 102 may communicate via a formed Wi-Fi connection and/or other wireless communication connection, the formation of which may disrupt internet service, and acquire the parcel data (e.g., associated with the parcel the mobile device 106 and the unmanned aerial vehicle 102 are presumed to be located, but which may be subsequently verifiable) from the server 108 before there is a risk of losing internet service.

It should be appreciated that, in the illustrative embodiment, the system 100 incorporates a suite of mobile device 106 capabilities that automatically combine normal manual control of an unmanned aerial vehicle 102 with intelligent movement changes (e.g., steering and accelerating) based on the context (e.g., the spatiotemporal context) of the unmanned aerial vehicle 102. For example, the spatiotemporal context may include the current and/or recent values associated with the location of the unmanned aerial vehicle 102, the movement angle and velocity (e.g., as a vector) of the unmanned aerial vehicle 102, atmospheric effects on the unmanned aerial vehicle 102 (e.g., wind angle and velocity), the property or geographic region (e.g., parcel of land) that the unmanned aerial vehicle 102 is on and/or characteristics of that property (e.g., parcel boundaries, property owner(s), etc.), nearby features (e.g., water bodies, buildings, roads, etc.), and/or other relevant contextual information.

In traditional flight, the user typically manipulates inputs on a remote controller 104 to control movement of the unmanned aerial vehicle 102 (e.g., via various input switches, wheels, sticks, buttons, etc.), and the unmanned aerial vehicle 102 alters its pitch, roll, and/or yaw of its throttles/propellers to reflect the intent of the user's control inputs. As described below, in the illustrative embodiment, the mobile application executing on the mobile device 106 “intercepts” the user's control input (e.g., from the remote controller 104 or directly via the mobile device 106), potentially alters the input depending on various factors to ensure that the movement of the unmanned aerial vehicle 102 is restricted to within a geofenced region (e.g., defined by the land parcel(s) from which the unmanned aerial vehicle 102 was launched), and transmits the potentially altered control input to the unmanned aerial vehicle 102. For example, the unmanned aerial vehicle 102 may be slowed down in the direction of movement toward a nearby (e.g., within 100 m) parcel boundary, and the movement may be unaltered in other directions and/or outside of a threshold distance from the parcel boundary.

It should be appreciated that the property or properties that the unmanned aerial vehicle 102 is restricted to stay within may be manually selected by the user, automatically defined as the property or properties that the unmanned aerial vehicle 102 took off from, defined as the property or properties that the unmanned aerial vehicle 102 is currently within or has passed through, defined as the property or properties related to any of such properties, and/or otherwise defined depending on the particular embodiment. Further, in some embodiments, the mobile application may impose constraints that restrict the unmanned aerial vehicle 102 from entering a particular area (e.g., within the parcel boundary) such as, for example, bodies of water, buildings, roads, other restricted areas, and/or buffer/offset regions thereof. For example, in embodiments involving buffer regions, the buffer may be uniform (e.g., a 20 meter or otherwise defined consistent buffer around an entire restricted area) or non-uniform (e.g., varying across the border of a particular restricted area) depending on the particular embodiment. In various embodiments, the geographical region within which movement of the unmanned aerial vehicle 102 is restricted may be predefined before flight, determined upon take off, and/or modified as the flight progresses. As described below, in the illustrative embodiment, the mobile device 106 may identify the geofence boundaries and/or other map features by transmitting the location of the unmanned aerial vehicle 102 to the server 108 for comparison to a database and/or other data stored thereon.

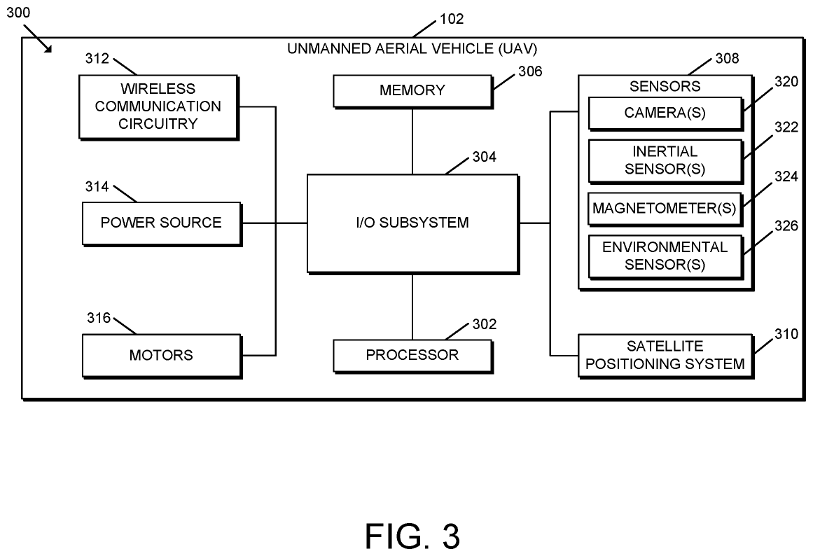

In the illustrative embodiment, the unmanned aerial vehicle 102 is embodied as a drone. However, in other embodiments, the unmanned aerial vehicle 102 may be embodied as any type of unmanned aerial vehicle capable of relatively stationary suspension within air and/or otherwise performing the functions described herein (e.g., a remote operated helicopter). Further, in some embodiments, the techniques described herein may be similarly employed with respect to non-aerial unmanned vehicles (e.g., remote controlled cars, remote controlled watercraft, remote controlled amphibious vehicles, etc.) to restrict the land-based movement and/or water-based (or other fluid-based) movement of such vehicles to within the restricted geographical region. In the illustrative embodiment, the unmanned aerial vehicle 102 includes the control system 300 of FIG. 3 described below for controlling the various operations of the unmanned aerial vehicle 102. In some embodiments, the unmanned aerial vehicle 102 may communicate with the remote controller 104 and/or the mobile device 106 via a Wi-Fi wireless communication link, an OcuSync wireless communication link, a Lightbridge wireless communication link, and/or another suitable wireless communication link.

The remote controller 104 may be embodied as any type of device or collection of devices for remotely controlling the unmanned aerial vehicle 102 and/or otherwise performing the functions described herein. For example, the remote controller 104 includes multiple input components such as one or more input sticks, input wheels, input switches, input buttons, and/or other input components to receive various control inputs from the user regarding the operations of the unmanned aerial vehicle 102. It should be appreciated that the user inputs may be transmitted to the unmanned aerial vehicle 102 and processed thereon to control the movement (e.g., pitch, roll, yaw, and motor throttles) of the unmanned aerial vehicle 102, the capturing of images by a camera 320 and/or movement of a corresponding camera gimbal, and/or other operations of the unmanned aerial vehicle 102. In other embodiments, it should be appreciated that the remote controller 104 may be omitted from the system 100, and the operations of the unmanned aerial vehicle 102 may be controlled directly via the mobile device 106. For example, in some embodiments, the unmanned aerial vehicle 102 may be placed in a “virtual stick” mode such that the mobile application of the mobile device 106 may control the operations of the unmanned aerial vehicle 102 via an API.

The mobile device 106 may be embodied as any type of computing device that is configured to communicate with the server 108 to receive geographical data as described herein and to wirelessly communicate with the unmanned aerial vehicle 102 to transmit various potentially modified control commands as described herein. Further, in some embodiments, the mobile device 106 is configured to “intercept” or otherwise receive user input control commands from the remote controller 104 for processing as indicated above. In some embodiments, the mobile device 106 may establish a suitable wireless communication link with the remote controller 104 to receive such data. Additionally, it should be appreciated that the mobile device 106 may communicate with the server 108 via any suitable communication technology.

The server 108 may be embodied as any type of device or collection of devices suitable for performing the functions described herein. More specifically, in the illustrative embodiment, the server 108 is configured to receive location data identifying a current geographical location of the unmanned aerial vehicle 102 and compare that location data to a database and/or other relevant comparison data to determine various geographical region information associated with the current location of the unmanned aerial vehicle 102. For example, in some embodiments, the server 108 may identify the land parcel associated with the location of the unmanned aerial vehicle 102 and various features or characteristics of that land parcel. More specifically, the server 108 may retrieve or construct map features related to the land parcel including the parcel boundaries, nearby buildings, water bodies, hazards, and/or other relevant features. Further, in some embodiments, the server 108 may retrieve or construct the map features as polygonal geofence boundaries (e.g., defined by line segments). It should be appreciated that the server 108 transmits the parcel data to the mobile device 106 for processing thereon to restrict the movement of the unmanned aerial vehicle 102 to within such boundaries as described herein. As described herein, in various embodiments, the geographical boundaries within which the unmanned aerial vehicle 102 may operate (e.g., within which the unmanned aerial vehicle 102 is to be geofenced) may be user-selected and/or may include one or more parcels.

It should be further appreciated that, although the server 108 is described herein as one or more computing devices outside of a cloud computing environment, in other embodiments, the server 108 may be embodied as a cloud-based device or collection of devices. Further, in cloud-based embodiments, the server 108 may be embodied as a server-ambiguous computing solution, for example, that executes a plurality of instructions on-demand, contains logic to execute instructions only when prompted by a particular activity/trigger, and does not consume computing resources when not in use. That is, the server 108 may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the server 108 described herein. For example, when an event occurs (e.g., data is transferred to the server 108 for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of updated access control data is made by a user (e.g., via an appropriate user interface to the server 108), the appropriate virtual function(s) may be executed to perform the actions before eliminating the instance of the virtual function(s).

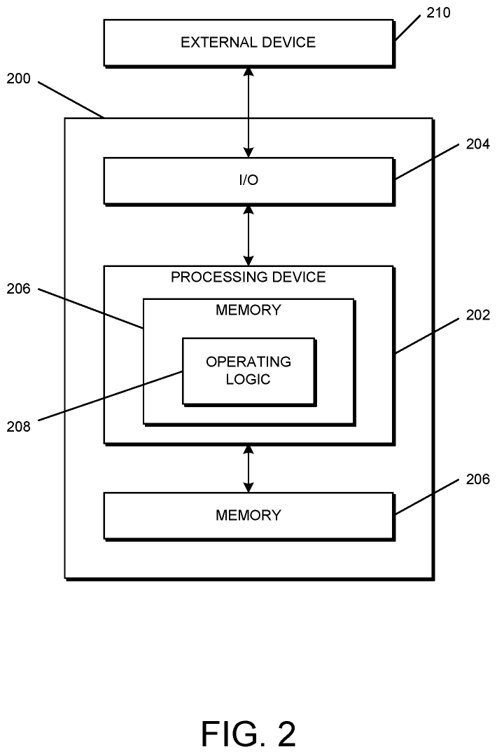

It should be appreciated that each of the remote controller 104, the mobile device 106, and/or the server 108 may be embodied as a computing device similar to the computing device 200 described below in reference to FIG. 2. For example, in the illustrative embodiment, each of the remote controller 104, the mobile device 106, and the server 108 includes a processing device 202 and a memory 206 having stored thereon operating logic 208 for execution by the processing device 202 for operation of the corresponding device. Additionally, it should be appreciated that the control system 300 of the unmanned aerial vehicle 102 may include features similar to the features described below in reference to the computing device 200 of FIG. 2.

Although only one unmanned aerial vehicle 102, one remote controller 104, one mobile device 106, and one server 108 are shown in the illustrative embodiment of FIG. 1, the system 100 may include multiple unmanned aerial vehicles 102, remote controllers 104, mobile devices 106, and/or servers 108 in other embodiments. For example, in some embodiments, the system 100 may include multiple servers 108 (e.g., in a cloud computing environment) that collectively perform the various functions of the server 108 described herein.

Referring now to FIG. 2, a simplified block diagram of at least one embodiment of a computing device 200 is shown. The illustrative computing device 200 depicts at least one embodiment of a remote controller, mobile device, and/or server that may be utilized in connection with the remote controller 104, the mobile device 106, and/or the server 108 illustrated in FIG. 1. Depending on the particular embodiment, the computing device 200 may be embodied as a remote control device, mobile computing device, cellular phone, smartphone, wearable computing device, personal digital assistant, laptop computer, tablet computer, notebook, netbook, Ultrabook™, server, desktop computer, Internet of Things (IoT) device, processing system, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as the unmanned aerial vehicle 102, the remote controller 104, the mobile device 106, and/or the server 108. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

Referring now to FIG. 3, a simplified block diagram of at least one embodiment of the control system 300 of the unmanned aerial vehicle 102 is shown. The illustrative control system 300 includes a processor 302, an input/output (“I/O”) subsystem 304, a memory 306, one or more sensors 308, a satellite positioning system 310, wireless communication circuitry 312, a power source 314, and one or more motors 316. It should be appreciated that one or more of the components of the control system 300 described herein may be embodied as, or form a portion of, one or more embedded controllers and/or integrated circuits of the unmanned aerial vehicle 102. For example, in some embodiments, the processor 302, the I/O subsystem 304, the memory 306, and/or other components of the control system 300 may be embodied as, or form a portion of, a microcontroller or SoC. Further, depending on the particular embodiment, the components of the control system 300 may be closely positioned to one another or distributed throughout the unmanned aerial vehicle 102 (i.e., separated from one another).

The processor 302 may be embodied as any type of processor(s) capable of performing the functions described herein. In particular, the processor 302 may be embodied as one or more single or multi-core processors, microcontrollers, or other processor or processing/controlling circuits. For example, in some embodiments, the processor 302 may include or be embodied as an arithmetic logic unit (ALU), central processing unit (CPU), digital signal processor (DSP), and/or another suitable processor(s). The processor 302 may be a programmable type, a dedicated hardwired state machine, or a combination thereof. One or more processors 302 with multiple processing units may utilize distributed, pipelined, and/or parallel processing in various embodiments. Further, the processor 302 may be dedicated to performance of just the operations described herein, or may be utilized in one or more additional applications. In the illustrative embodiment, the processor 302 is of a programmable variety that executes algorithms and/or processes data in accordance with operating logic as defined by programming instructions (such as software or firmware) stored in the memory 306. Additionally or alternatively, the operating logic for the processor 302 may be at least partially defined by hardwired logic or other hardware. Further, the processor 302 may include one or more components of any type suitable to process the signals received from input/output devices or from other components or devices and to provide desired output signals. Such components may include digital circuitry, analog circuitry, or a combination thereof.

The memory 306 may be of one or more types of non-transitory computer-readable media, such as a solid-state memory, electromagnetic memory, optical memory, or a combination thereof. Furthermore, the memory 306 may be volatile and/or nonvolatile and, in some embodiments, some or all of the memory 306 may be of a portable variety, such as a disk, tape, memory stick, cartridge, and/or other suitable portable memory. In operation, the memory 306 may store various data and software used during operation of the unmanned aerial vehicle 102 such as operating systems (e.g., real-time operating systems (RTOS)), applications, programs, libraries, and drivers. The memory 306 is communicatively coupled to the processor 302 via the I/O subsystem 304, which may be embodied as circuitry and/or components to facilitate input/output operations with the processor 302, the memory 306, and other components of the control system 300. For example, the I/O subsystem 304 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. Depending on the particular embodiment, the memory 306 may be included with the processor 302 and/or coupled to the processor 302 depending on the particular embodiment. For example, in some embodiments, the processor 302, the I/O subsystem 304, the memory 306, and/or other components of the control system 300 may form a portion of a system-on-a-chip (SoC) and be incorporated on a single integrated circuit chip.

The sensors 308 are configured to generate sensor data (e.g., by virtue of one or more signals), which may be interpreted by the processor 302 to determine one or more characteristics associated with the control system 300 and/or the associated unmanned aerial vehicle 102. By way of example, the sensors 308 may detect various characteristics of the physical environment of the associated unmanned aerial vehicle 102 (internal and/or external to the vehicle 102), electrical characteristics of the unmanned aerial vehicle 102, electromagnetic characteristics of the unmanned aerial vehicle 102 and/or its surroundings, and/or other suitable characteristics. In particular, in the illustrative embodiment, the sensors 308 include one or more cameras 320, inertial sensors 322, magnetometers 324, and environmental sensors 326.

Each of the camera(s) 320 may be embodied as any type of device capable of capturing one or images discretely or in a stream. For example, the camera(s) 320 may include one or more two-dimensional (2D) cameras, three-dimensional (3D) cameras, and/or video cameras. It should be appreciated that each of the cameras 320 may be positioned in any suitable location(s) depending on the particular unmanned aerial vehicle 102 including the control system 300 and the specific implementation. As such, depending on the particular embodiment, each of the cameras 320 may be secured to, integrated with, embedded within, and/or otherwise attached to the unmanned aerial vehicle 102. In some embodiments, the camera(s) 320 may be configured to stream video from the environment of the unmanned aerial vehicle 102 to another device (e.g., the mobile device 106). One or more of the cameras 320 may be secured to the unmanned aerial vehicle 102 and positioned for capturing images via a gimbal in some embodiments, whereas the cameras 320 may be otherwise secured to the unmanned aerial vehicle 102 in other embodiments.

Each of the inertial sensors 322 may be embodied as an accelerometer, gyroscope, and/or other suitable inertial sensor configured to generate data associated with the motion of the unmanned aerial vehicle 102. For example, in the illustrative embodiment, the inertial sensors 322 are configured to measure linear acceleration and/or angular velocity of the unmanned aerial vehicle 102. The magnetometer(s) 324 are configured to measure magnetic fields (e.g., Earth's magnetism) to determine the heading of the unmanned aerial vehicle 102. As such, in some embodiments, the magnetometer(s) 324 may be embodied as a compass. Each of the environmental sensors 326 may be embodied as any type of sensor capable of measuring one or more characteristics of the physical environment of the unmanned aerial vehicle 102. For example, the environmental sensors 326 may include one or more temperature sensors, air pressure sensors, humidity sensors (e.g., hygrometers), hydrometers, light sensors, wind sensors, and/or other environmental sensors.

It should be appreciated that the sensors 308 may be embodied as, or otherwise include, other sensors in other embodiments. For example, in various embodiments, the sensors 308 may be embodied as, or otherwise include, other environmental sensors, inertial sensors, proximity sensors, optical sensors, electromagnetic sensors, audio sensors, motion sensors, piezoelectric sensors, cameras, and/or other types of sensors. It should be appreciated that, in some embodiments, additional and/or alternative sensors 308 other than those described above may be included in the control system 300. Of course, the control system 300 may also include components and/or devices configured to facilitate the use of the sensors 308.

The satellite positioning system 310 is configured to generate data indicative of, or otherwise able to be processed to determine, the location of the unmanned aerial vehicle 102. For example, in some embodiments, the satellite positioning system 310 may be embodied as Global Positioning System (GPS) circuitry and/or Global Navigation Satellite System (GLONASS) circuitry. In particular, in some embodiments, the satellite positioning system 310 may be embodied as a dual GPS/GLONASS positioning system. In other embodiments, the satellite positioning system 310 may, additionally or alternatively, include circuitry for communication with the GALILEO global positioning service, the BeiDou Navigation Satellite System, the Indian Regional Navigation Satellite System (IRNSS), and/or one or more other satellite positioning services. It should be appreciated that the satellite positioning system 310 generates position/location data indicative of a geographical location of the unmanned aerial vehicle 102 at a given point in time. In some embodiments, the position/location data may be represented as longitudinal and latitudinal coordinates of the unmanned aerial vehicle 102, whereas in other embodiments, the location data may be otherwise represented.

The wireless communication circuitry 312 may be embodied as any communication circuitry, transceiver, device, or collection thereof, capable of enabling wireless communication between the unmanned aerial vehicle 102 and other remote devices (e.g., the remote controller 104 and/or the mobile device 106). The wireless communication circuitry 312 may be configured to use any one or more wireless communication technologies and associated protocols. For example, as indicated above, the illustrative wireless communication circuitry 312 may enable the unmanned aerial vehicle 102 to communicate via a Wi-Fi communication protocol, an OcuSync communication protocol, and/or a Lightbridge communication protocol. In other embodiments, the wireless communication circuitry 312 enables the unmanned aerial vehicle 102 to communicate with remote devices via cellular communication (i.e., over a cellular communication network), using satellite communication (e.g., via geosynchronous or low Earth orbit (LEO) satellite systems), and/or via another suitable mid-range or long-range wireless communication technology.

In the illustrative embodiment, the power source 314 is an independent, untethered, and portable power source configured to supply power to the control system 300 of the unmanned aerial vehicle 102 to perform the various functions described herein. For example, the power source 314 may include one or more batteries, battery packs, capacitors, super capacitors, solar cells, and/or other power supplies. Depending on the particular embodiment, the power source 314 may be rechargeable and/or replaceable.

Each of the illustrative motors 316 is configured to rotate one or more rotors/propellers of the unmanned aerial vehicle 102 to propel the unmanned aerial vehicle 102 in a corresponding direction. Additionally, the control system 300 may include one or more speed controllers and/or other components to facilitate the operation of the motors 316. It should be appreciated that multiple motors 316 may work in concert to change the pitch, roll, and/or yaw of the unmanned aerial vehicle 102 to move the unmanned aerial vehicle 102 in the corresponding direction. In other embodiments, the motors 316 may be configured to control one or more corresponding components to otherwise propel/thrust the unmanned aerial vehicle 102 in a particular direction. It should be appreciated that the control system 300 may include additional or alternative components, such as those commonly found in an embedded control system, for example, in other embodiments.

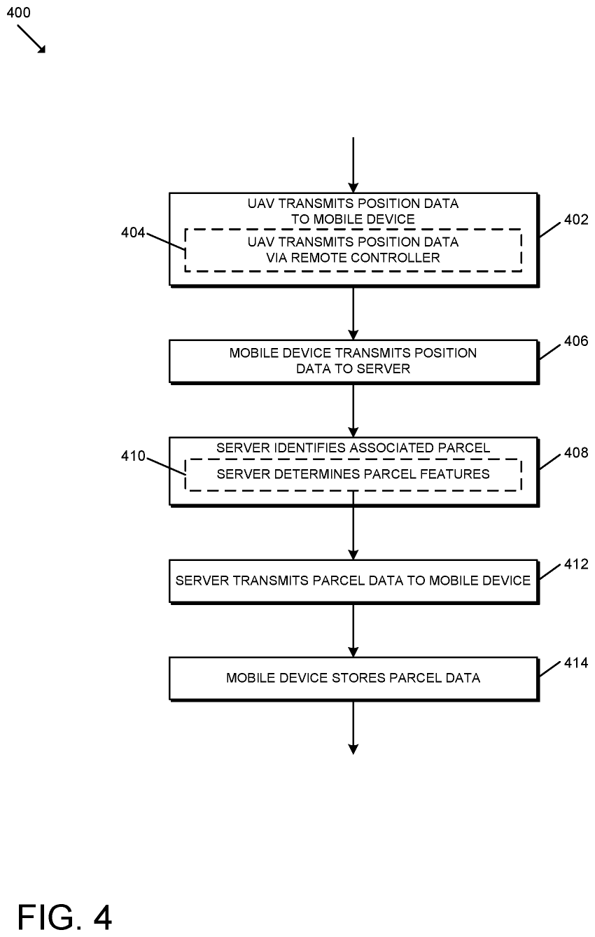

Referring now to FIG. 4, in use, the system 100 may execute a method 400 for registering the location of the unmanned aerial vehicle 102. It should be appreciated that the particular blocks of the method 400 are illustrated by way of example, and such blocks may be combined or divided, added or removed, and/or reordered in whole or in part depending on the particular embodiment, unless stated to the contrary. The illustrative method 400 begins with block 402 in which the unmanned aerial vehicle 102 transmits position/location data of the unmanned aerial vehicle 102 (e.g., generated by the satellite positioning system 310) to the mobile device 106. In some embodiments, in block 404, the unmanned aerial vehicle 102 may transmit such position/location data via the remote controller 104. For example, in some embodiments, the user may use the remote controller 104 to control the unmanned aerial vehicle 102, in which case the mobile device 106 may “intercept” and/or otherwise receive data transmitted to and/or from the remote controller 104 as described above. Further, as described above, the mobile device 106 may directly communicate with the unmanned aerial vehicle 102 in other embodiments (e.g., using a “virtual stick” control mode of the unmanned aerial vehicle 102).

In block 406, the mobile device 106 transmits the position/location data to the server 108 and, in block 408, the server 108 identifies the land parcel associated with the current location of the unmanned aerial vehicle 102 based on the position/location data. In particular, in block 410, the server 108 may determine one or more features of the land parcel. For example, in some embodiments, the server 108 may compare that location data to a database of land parcel data and/or other relevant comparison data to determine various geographical region information associated with the current location of the unmanned aerial vehicle 102. More specifically, in some embodiments, the server 108 may retrieve or construct map features related to the land parcel including the parcel boundaries, nearby buildings, water bodies, hazards, and/or other relevant features. Further, in some embodiments, the server 108 may retrieve or construct the map features as polygonal geofence boundaries (e.g., defined by line segments).

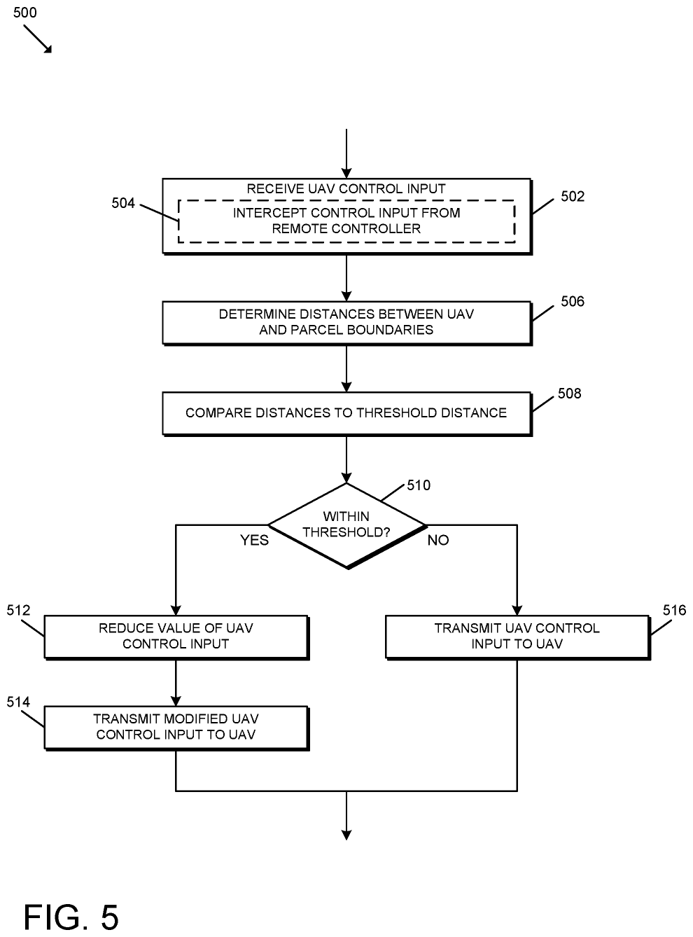

In block 412, the server 108 transmits the parcel data (e.g., the parcel identity, parcel characteristics, map features, parcel boundaries, and/or other relevant data) to the mobile device 106 and, in block 414, the mobile device 106 stores the parcel data to the memory of the mobile device 106 for subsequent processing by the mobile device 106 to restrict the movement of the unmanned aerial vehicle 102 to within the boundaries defined by the parcel data. As described above, the parcel data may be retrieved for restricting the movement of the unmanned aerial vehicle 102 in response to user input, takeoff of the unmanned aerial vehicle 102, and/or in response to the satisfaction of another condition in other embodiments. In some embodiments, the method 400 of FIG. 4 is only executed once to store the parcel data to the mobile device 106, and the current position of the unmanned aerial vehicle 102 is subsequently compared to the stored parcel data as described below in reference to FIG. 5. Further, in some embodiments, the parcel data may be periodically updated by re-executing the method 400 of FIG. 4.

Although the blocks 402-414 are described in a relatively serial manner, it should be appreciated that various blocks of the method 400 may be performed in parallel in some embodiments.

Referring now to FIG. 5, in use, the system 100 may execute a method 500 for geofencing the unmanned aerial vehicle 102. It should be appreciated that the particular blocks of the method 500 are illustrated by way of example, and such blocks may be combined or divided, added or removed, and/or reordered in whole or in part depending on the particular embodiment, unless stated to the contrary. The illustrative method 500 begins with block 502 in which the mobile device 106 receives one or more user control inputs regarding the operation of the unmanned aerial vehicle 102. For example, in some embodiments, the user may control the unmanned aerial vehicle 102 using the remote controller 104 as described above. Accordingly, in block 504, the mobile device 106 may “intercept” the control input from the remote controller 104 before the control input is transmitted to the unmanned aerial vehicle 102 as described above. In other embodiments, however, the mobile device 106 may directly control the unmanned aerial vehicle 102 via the mobile device 106 (e.g., via a graphical user interface of a mobile application executing on the mobile device 106).

In block 506, the mobile device 106 determines the distances between the unmanned aerial vehicle 102 and the parcel boundaries. For example, in some embodiments, the mobile device 106 may identify the nearest boundary to the unmanned aerial vehicle 102 in each direction (e.g., the directions about which the unmanned aerial vehicle 102 rolls and pitches) and determine the distance between the unmanned aerial vehicle 102 and each such boundary. In block 508, the mobile device 106 compares the distances to a threshold distance to determine whether the unmanned aerial vehicle 102 is within a certain distance (e.g., a buffer distance) from a parcel boundary. In some embodiments, the threshold distance may be one hundred meters, whereas in other embodiments, the threshold distance may vary. Further, in some embodiments, each boundary (and/or portions thereof) may correspond with a different threshold distance against which the distance between the unmanned aerial vehicle 102 and that boundary region is compared. Further, in some embodiments, the threshold distance may be relative to an offset from the actual parcel boundaries as described above.

If the mobile device 106 determines, in block 510, that the unmanned aerial vehicle 102 is within the threshold distance of one or more parcel boundaries, the method 500 advances to block 512 in which the mobile device 106 modifies the value of one or more of the control inputs to the unmanned aerial vehicle 102 to reduce the speed of the unmanned aerial vehicle 102 in that direction. In some embodiments, it should be appreciated that the speed of the unmanned aerial vehicle 102 may be reduced logarithmically beginning at the threshold distance and ending adjacent the parcel boundary. As such, the reduction in speed of the unmanned aerial vehicle 102 may be initially unnoticeable (e.g., until approximately halfway between the threshold distance and the boundary), and the speed of the unmanned aerial vehicle 102 in the direction of the boundary is zero when the unmanned aerial vehicle 102 is directly adjacent that boundary. In other embodiments, it should be appreciated that the speed of the unmanned aerial vehicle 102 may be otherwise reduced (e.g., linearly, piecewise linearly, and/or according to another monotonically decreasing function). Further, in some embodiments, the speed of the unmanned aerial vehicle 102 may be reduced as a percentage of the input control speed.

In block 514, the mobile device 106 transmits the modified control inputs to the unmanned aerial vehicle 102 to control movement of the unmanned aerial vehicle 102. It should be appreciated that, in some embodiments, the movement of the unmanned aerial vehicle 102 in each coordinate direction (e.g., the axes about which the unmanned aerial vehicle 102 pitches and rolls) may be evaluated independently. For example, movement of the unmanned aerial vehicle 102 in the forward/back direction may be evaluated independently of movement of the unmanned aerial vehicle 102 in the left/right direction. Accordingly, in such embodiments, it should be appreciated that the unmanned aerial vehicle 102 may operate in full speed adjacent a boundary provided that the unmanned aerial vehicle 102 is not moving toward that boundary. Returning to block 510, if no distance between the unmanned aerial vehicle 102 and a parcel boundary is within a corresponding threshold distance, the method 500 advances to block 516 in which the mobile device 106 transmits the unmodified control input to the unmanned aerial vehicle 102.

Although not described herein for brevity of the description, it should be appreciated that the mobile device 106 may further consider one or more spatiotemporal contexts, sensor data, and/or other relevant data in determining the appropriate modification of the input control values.

Although the blocks 502-516 are described in a relatively serial manner, it should be appreciated that various blocks of the method 400 may be performed in parallel in some embodiments.

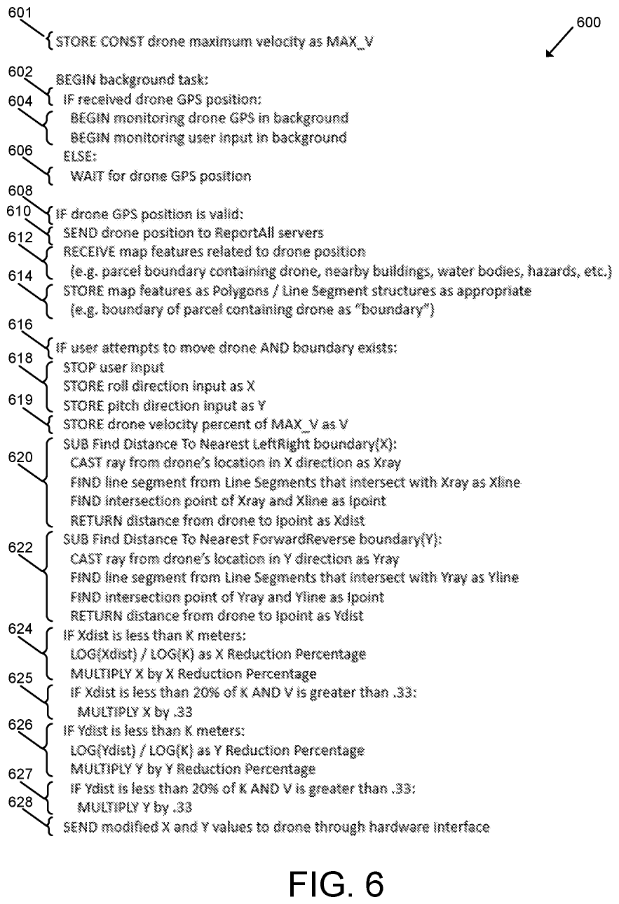

Referring now to FIG. 6, at least one embodiment of pseudocode 600 for executing the methods 400, 500 of FIGS. 4-5 is shown. It should be appreciated that code 602-606 corresponds with beginning a background task of monitoring the position of the unmanned aerial vehicle 102 by the mobile device 106, code 608-614 corresponds with registering the location of the unmanned aerial vehicle 102 (see, for example, the method 400 of FIG. 4), and code 616-628 corresponds with geofencing the unmanned aerial vehicle 102 (see, for example, the method 500 of FIG. 5).

More specifically, in code 601, the mobile device 106 determines the maximum velocity of the unmanned aerial vehicle 102 and stores the maximum velocity as a constant value (MAX_V). It should be appreciated that the maximum velocity may be predefined, estimated, user-supplied, and/or otherwise determined depending on the particular embodiment. In some embodiments, it should be appreciated that the maximum velocity in the roll direction may differ from the maximum velocity in the pitch direction and, therefore, the maximum velocity in each such direction may be stored accordingly (e.g., MAX_V_{X} and MAX_V_{Y}, respectively). In code 602, the mobile device 106 determines whether the position/location data of the unmanned aerial vehicle 102 has been received. If so, in code 604, the mobile device 106 begins monitoring the location data (e.g., from the satellite positioning system 310) received from the unmanned aerial vehicle 102 and the user control inputs (e.g., directly via the mobile device 106 or as intercepted from the remote controller 104) in the background. If not, in code 606, the mobile device 106 waits until the position/location data of the unmanned aerial vehicle 102 has been received.

In code 608, the mobile device 106 determines whether the position/location of the unmanned aerial vehicle 102 is valid and, if so, the mobile device 106 transmits the location data to the server 108 in code 610. In code 612, the mobile device 106 receives various map features related to the position of the unmanned aerial vehicle 102 as described above. For example, in some embodiments, the map features may include the parcel boundaries of the land parcel within which the unmanned aerial vehicle 102 is located, nearby buildings, water bodies, hazards, and/or other map features. In code 614, the mobile device 106 stores the map features as polygonal geofence boundaries (e.g., defined by line segments), which may appropriately identify the boundaries of the land parcel. It should be appreciated that the map features may further include other geospatial boundaries in other embodiments. For example, in some embodiments, the map features may include one or more boundaries associated with or defined by a system of the unmanned aerial vehicle 102 and/or the remote controller 104 (e.g., boundaries defined by the manufacturer(s)), one or more boundaries defined by the Federal Aviation Administration (FAA) or other regulatory agencies, and/or one or more boundaries otherwise defined.

In code 616, the mobile device 106 determines whether the user has attempted to move the unmanned aerial vehicle 102 based on the user control input and whether a boundary exists in that direction. If so, in code 618, the mobile device 106 stops the user input (e.g., prevents the user input from being transmitted to the unmanned aerial vehicle 102), and independently stores the roll direction control input as X and the pitch direction control input as Y. In code 619, the mobile device 106 determines the current velocity of the unmanned aerial vehicle 102 as a percentage of its maximum velocity (MAX_V) and stores that percentage value (V). In some embodiments, it should be appreciated that the mobile device 106 may determine the vector components of the current velocity of the unmanned aerial vehicle 102 and/or otherwise determine the current velocity of the unmanned aerial vehicle 102 in each of the roll direction (V_{X}) and the pitch direction (V_{Y}) and store those percentage values accordingly.

In code 620, the mobile device 106 executes a subroutine to determine the distance between the unmanned aerial vehicle 102 and the nearest boundary in the left/right direction (e.g., in the roll direction along the x-axis) relative to the current heading of the unmanned aerial vehicle 102. To do so, the mobile device 106 may cast a ray from the location of the unmanned aerial vehicle 102 in the X direction and identify the line segment of the parcel boundary that intersects that ray and the intersection point thereof. The distance between the intersection point and the unmanned aerial vehicle 102 is returned as X_{DIST}. In code 622, the mobile device 106 executes a subroutine to determine the distance between the unmanned aerial vehicle 102 and the nearest boundary in the forward/reverse direction (e.g., in the pitch direction along the y-axis) relative to the current heading of the unmanned aerial vehicle 102, which is returned as Y_{DIST}. To do so, the subroutine of the code 622 is similar to that of the code 620 and, therefore, not repeated herein for brevity of the description.

In code 624, the mobile device 106 determines whether X_{DIST} is less than a threshold distance (e.g., K meters) and, if so, the mobile device 106 reduces the roll direction control input (X) by multiplying the input by a reduction percentage determined logarithmically according to log(X_{DIST})/log(K). In code 625, the mobile device 106 determines whether X_{DIST} is less than a predefined percentage (e.g., 20%) of the threshold distance (e.g., K meters) and also whether the percentage value (e.g., V or V_{X} depending on the particular embodiment) of the maximum velocity (MAX_V or MAX_V_{X}) is greater than a predefined percentage (e.g., 33%). It should be appreciated that the predefined percentages may be the same or different depending on the particular embodiment. If X_{DIST} is less than the predefined percentage of the threshold distance and the percentage value (V or V_{X}) of the maximum velocity is greater than the predefined percentage, then the mobile device 106 reduces the roll direction control input (X) by multiplying the input by a predefined reduction percentage (e.g., 33%).

In code 626, the mobile device 106 determines whether Y_{DIST} is less than a threshold distance (e.g., K meters) and, if so, the mobile device 106 reduces the pitch direction control input (Y) by multiplying the input by a reduction percentage determined logarithmically according to log(Y_{DIST})/log(K). In code 627, the mobile device 106 determines whether Y_{DIST} is less than a predefined percentage (e.g., 20%) of the threshold distance (e.g., K meters) and also whether the percentage value (e.g., V or V_{Y} depending on the particular embodiment) of the maximum velocity (MAX_V or MAX_V_{Y}) is greater than a predefined percentage (e.g., 33%). It should be appreciated that the predefined percentages may be the same or different depending on the particular embodiment. If Y_{DIST} is less than the predefined percentage of the threshold distance and the percentage value (V or V_{X}) of the maximum velocity is greater than the predefined percentage, then the mobile device 106 reduces the pitch direction control input (Y) by multiplying the input by a predefined reduction percentage (e.g., 33%).

In code 628, the mobile device 106 transmits the modified control inputs (or unmodified control inputs if code 624-627 is not executed) to the unmanned aerial vehicle 102 via a corresponding hardware interface. It should be appreciated that, in some embodiments, one or more of the codes 601-627 of the pseudocode 600 may be omitted and/or modified. For example, in some embodiments, the pseudocode 600 may omit codes 601, 619, 625, and 627. In other embodiments, other of the codes 601-627 may be omitted. Further, in some embodiments, additional codes may be included, for example, which may have been omitted from the example pseudocode 600 for brevity of the description.

What is claimed is:

1. A method for geofencing an unmanned aerial vehicle, the method comprising:
receiving, by a mobile device, one or more control inputs to the unmanned aerial vehicle associated with movement of the unmanned aerial vehicle, wherein the one or more control inputs are received by the mobile device prior to transmittal to the unmanned aerial vehicle;
retrieving, by the mobile device, parcel data that identifies geographical boundaries of the land parcel within which the unmanned aerial vehicle is operating;
determining, by the mobile device, a distance between the unmanned aerial vehicle and a boundary of the land parcel;
reducing, by the mobile device, a speed value associated within the one or more control inputs to generate one or more modified control inputs in response to determining that the distance is within a threshold distance; and
transmitting, by the mobile device, the one or more modified control inputs to the unmanned aerial vehicle.

2. The method of claim 1, where reducing the speed value associated with the one or more control inputs comprises reducing the speed value logarithmically.

3. The method of claim 1, wherein reducing the speed value associated with the one or more control inputs comprises reducing the speed value in response to determining that the speed value exceeds a threshold percentage of a maximum velocity of the unmanned aerial vehicle.

4. The method of claim 1, wherein determining the distance between the unmanned aerial vehicle and the boundary comprises determining a first distance between the unmanned aerial vehicle and a first boundary of the land parcel in one of a roll direction or a pitch direction of the unmanned aerial vehicle; and
wherein reducing the speed value associated with the one or more control inputs comprises reducing a first speed value associated with a first control input to generate a first modified control input in response to determining that the first distance is within a first threshold distance.

5. The method of claim 4, further comprising:
determining, by the mobile device, a second distance between the unmanned aerial vehicle and a second boundary of the land parcel in the other of the roll direction or the pitch direction of the unmanned aerial vehicle; and
reducing, by the mobile device, a second speed value associated with a second control input to generate a second modified control input in response to determining that the first distance is within a second threshold distance.

6. The method of claim 5, wherein the second threshold distance is different from the first threshold distance.

7. The method of claim 4, further comprising:
determining, by the mobile device, a second distance between the unmanned aerial vehicle and a second boundary of the land parcel in the other of the roll direction or the pitch direction of the unmanned aerial vehicle; and
wherein transmitting the one or more modified control inputs to the unmanned aerial vehicle comprises transmitting the first modified control input associated with movement of the unmanned aerial vehicle in the one of the roll direction or the pitch direction and a second unmodified control input associated with movement of the unmanned aerial vehicle in the other of the roll direction of the pitch direction in response to determining that the second distance is not within a second threshold distance.

8. The method of claim 1, further comprising:
transmitting, by the mobile device and to a server, location data identifying a current location of the unmanned aerial vehicle;
receiving, by the mobile device, the parcel data from the server in response to transmitting the location data of the unmanned aerial vehicle; and
storing, by the mobile device, the parcel data to a memory of the mobile device;
wherein retrieving the parcel data comprises retrieving the parcel data from the memory of the mobile device.

9. A mobile device for controlling the operation of an unmanned aerial vehicle, the mobile device comprising:
a processor; and
a memory comprising a plurality of instructions stored thereon that, in response to execution by the processor, causes the mobile device to:
receive one or more control inputs to the unmanned aerial vehicle associated with movement of the unmanned aerial vehicle, wherein the one or more control inputs are received by the mobile device prior to transmittal to the unmanned aerial vehicle;
retrieve parcel data that identifies geographical boundaries of the land parcel within which the unmanned aerial vehicle is operating;
determine a distance between the unmanned aerial vehicle and a boundary of the land parcel;
reduce a speed value associated within the one or more control inputs to generate one or more modified control inputs in response to determining that the distance is within a threshold distance; and
transmit the one or more modified control inputs to the unmanned aerial vehicle.

10. The mobile device of claim 9, where to reduce the speed value associated with the one or more control inputs comprises to reduce the speed value logarithmically.

11. The mobile device of claim 9, wherein to reduce the speed value associated with the one or more control inputs comprises to reduce the speed value in response to a determination that the speed value exceeds a threshold percentage of a maximum velocity of the unmanned aerial vehicle.

12. The mobile device of claim 9, wherein to determine the distance between the unmanned aerial vehicle and the boundary comprises to determine a first distance between the unmanned aerial vehicle and a first boundary of the land parcel in one of a roll direction or a pitch direction of the unmanned aerial vehicle; and
wherein to reduce the speed value associated with the one or more control inputs comprises to reduce a first speed value associated with a first control input to generate a first modified control input in response to determining that the first distance is within a first threshold distance.

13. The mobile device of claim 12, wherein the plurality of instructions further causes the mobile device to (i) determine a second distance between the unmanned aerial vehicle and a second boundary of the land parcel in the other of the roll direction or the pitch direction of the unmanned aerial vehicle and (ii) reduce a second speed value associated with a second control input to generate a second modified control input in response to determining that the first distance is within a second threshold distance.

14. The mobile device of claim 13, wherein the second threshold distance is different from the first threshold distance.

15. The mobile device of claim 12, wherein the plurality of instructions further causes the mobile device to determine a second distance between the unmanned aerial vehicle and a second boundary of the land parcel in the other of the roll direction or the pitch direction of the unmanned aerial vehicle; and
wherein transmittal of the one or more modified control inputs to the unmanned aerial vehicle comprises transmittal of the first modified control input associated with movement of the unmanned aerial vehicle in the one of the roll direction or the pitch direction and a second unmodified control input associated with movement of the unmanned aerial vehicle in the other of the roll direction of the pitch direction in response to a determination that the second distance is not within a second threshold distance.

16. The mobile device of claim 9, wherein the plurality of instructions further causes the mobile device to (i) transmit location data to a server identifying a current location of the unmanned aerial vehicle, (ii) receive the parcel data from the server in response to transmitting the location data of the unmanned aerial vehicle, and (iii) store the parcel data to a memory of the mobile device; and
wherein to retrieve the parcel data comprises to retrieve the parcel data from the memory of the mobile device.

17. One or more non-transitory machine-readable storage media comprising a plurality of instructions stored thereon that, in response to execution by a processor, causes a computing device to:
receive one or more control inputs to the unmanned aerial vehicle associated with movement of the unmanned aerial vehicle, wherein the one or more control inputs are received by the computing device prior to transmittal to the unmanned aerial vehicle;
retrieve parcel data that identifies geographical boundaries of the land parcel within which the unmanned aerial vehicle is operating;
determine a distance between the unmanned aerial vehicle and a boundary of the land parcel;
reduce a speed value associated within the one or more control inputs to generate one or more modified control inputs in response to determining that the distance is within a threshold distance; and
transmit the one or more modified control inputs to the unmanned aerial vehicle.

18. The one or more non-transitory machine-readable storage media of claim 17, wherein to determine the distance between the unmanned aerial vehicle and the boundary comprises to determine a first distance between the unmanned aerial vehicle and a first boundary of the land parcel in one of a roll direction or a pitch direction of the unmanned aerial vehicle; and
wherein to reduce the speed value associated with the one or more control inputs comprises to reduce a first speed value associated with a first control input to generate a first modified control input in response to a determination that the first distance is within a first threshold distance.

19. The one or more non-transitory machine-readable storage media of claim 18, wherein the plurality of instructions further causes the computing device to:
determine a second distance between the unmanned aerial vehicle and a second boundary of the land parcel in the other of the roll direction or the pitch direction of the unmanned aerial vehicle; and
reduce a second speed value associated with a second control input to generate a second modified control input in response to a determination that the first distance is within a second threshold distance.

20. The one or more non-transitory machine-readable storage media of claim 18, wherein the plurality of instructions further causes the computing device to:
determine a second distance between the unmanned aerial vehicle and a second boundary of the land parcel in the other of the roll direction or the pitch direction of the unmanned aerial vehicle; and
wherein to transmit the one or more modified control inputs to the unmanned aerial vehicle comprises to transmit the first modified control input associated with movement of the unmanned aerial vehicle in the one of the roll direction or the pitch direction and a second unmodified control input associated with movement of the unmanned aerial vehicle in the other of the roll direction of the pitch direction in response to a determination that the second distance is not within a second threshold distance.
